(19) United States
(12) Patent Application Publication
(10) Pub. No.: US 2014/0101442 A1
(43) Pub. Date: Apr. 10, 2014

(54) SYSTEM AND WEB SECURITY AGENT METHOD FOR CERTIFICATE AUTHORITY REPUTATION ENFORCEMENT

(71) Applicant: BARRACUDA NETWORKS, INC., Campbell, CA (US)

(72) Inventors: Stephen Pao, Los Altos, CA (US); Fleming Shi, Cupertino, CA (US)

(73) Assignee: BARRACUDA NETWORKS, INC., Campbell, CA (US)

(21) Appl. No.: 14/103,782

(22) Filed: Dec. 11, 2013

Related U.S. Application Data
(62) Division of application No. 13/751,080, filed on Jan. 26, 2013.
Application No. 13/751,080 is a division of application No. 13/225,371, filed on Sep. 2, 2011.

(51) Int. Cl. H04L 9/32

(52) U.S. Cl. CPC H04L 9/3268
USPC 713/158

(57) ABSTRACT

Network security administrators are enabled to revoke certificates with their customizable certificate authority reputation policy store which is informed by an independent certificate authority reputation server when a CA is deprecated or has fraudulent certificate generation. The custom policy store overrides trusted root certificate stores accessible to an operating system web networking layer or to a third party browser. Importing revocation lists or updating browsers or operating system is made redundant. The apparatus protects an endpoint from a man-in-the-middle attack when a certificate authority has lost control over certificates used in TLS.

### CROSS-REFERENCE TO RELATED APPLICATIONS

This application is a divisional of U.S. patent application Ser. No. 13/751,080, filed on Jan. 26, 2013, which is a further divisional of U.S. Ser. No. 13/225,371, filed on Sep. 2, 2011 and also claims priority to U.S. Ser. No. 13/225,432, filed on Sep. 3, 2011. The disclosures of all these applications are incorporated herein by reference in their entirety for all purposes.

### BACKGROUND OF THE INVENTION

### Conventional Transport Level Security

Transport Layer Security (TLS) is the most widely deployed protocol for securing communications in a non-secure environment, such as on the World Wide Web. The TLS protocol is used by most E-commerce and financial web sites, and is signified by the security lock icon that appears at the bottom of a web browser whenever TLS is activated. TLS guarantees privacy and authenticity of information exchanged between a web server and a web browser.

FIG. 1 is a block diagram that shows two standard network architectures 100a and 100b, a web server 104, a plurality of client web browsers 106, and a network 108. In the architecture of interest to this patent application, a Proxy 102 may include content processing capabilities, such as the content filters, web caches and content transformation engines described above. Although proxy 102 is depicted as including the content processing capabilities, it will be appreciated by those of ordinary skill in the art that such processing may occur in separate modules or devices.

When using the TLS protocol, a TLS session between a web server and a web browser occurs in two phases, an initial handshake phase and an application data phase. Regarding the initial handshake phase, when a web browser first connects to a web server using TLS, the browser and server execute the TLS handshake protocol. This execution generates TLS session keys, including a TLS session encryption key and a TLS session integrity key. These keys are known to the web server and the web browser, but are not known to any other devices or systems.

Once TLS session keys are established, the browser and server begin exchanging data in the application data phase. The data is encrypted using the TLS session encryption key and protected from tampering using the TLS session integrity key. When the browser and server are done exchanging data, the connection between them is closed.

The steps of the TLS initial handshake protocol between a client and a server provide context for the present invention, and are briefly described next. In describing the main steps of the initial handshake protocol, as an example, suppose the client is issuing a TLS request for the URL: https://www.xyz.com/first.html. The TLS handshake protocol begins with the client sending the server a client-hello message. The server then responds with a server-hello message. The client-hello and server-hello are used to establish the security capabilities between the client and server. If the server is to be authenticated, as it is for the present invention, the server then sends its public key server certificate. The server certificate binds the server's public-key to the server name. For example, when accessing the URL http://www.xyz.com/first.html, the server sends a certificate that identifies the server as www.xyz.com. The server certificate contains information that identifies the certificate format and name of the Certificate Authority issuing the certificate, and also contains two fields of particular interest: the server's public-key; and, the server's common name. The common name is set to the domain name of the server, which is www.xyz.com. When the client receives the server certificate it verifies (using a trusted root certificate store of the operating system or of the browser) that: the certificate is properly signed by a known Certificate Authority (such as VeriSign); and, the common name inside the certificate matches the domain name in the URL requested by the client. When requesting the URL http://www.xyz.com/first.html, the client verifies that the common name inside the certificate is www.xyz.com. If either of these tests fails, the client presents an error message to the user. The server may also request that the client be authenticated, in which case the client sends its public key client certificate. Once the client has the server's certificate (and if requested, the server has the client's certificate) the server and browser carry out a key exchange to establish the session encryption key and session integrity key. The TLS specification is documented in more detail in RFC 2246, “The TLS Protocol, Version 1.0”.

It is known that at least one fraudulent digital certificate has been issued from a root certificate authority. This was undetected for nearly two months.

### BRIEF SUMMARY OF THE INVENTION

Even though it is possible to revoke such a digital certificate, it still potentially affects Internet users attempting to access websites belonging to the legitimate certificate owner. A fraudulent certificate may be used to spoof Web content, perform phishing attacks, or perform man-in-the-middle attacks against end users.

Unfortunately, these trusted certificate authorities can get hacked in the modern day and the response requires removing a trusted root certificate from the list of trusted root certificates and rereleasing of operating systems updates, browsers, and other applications and further requires instant installation by every user. All too often however, users do not know what to do when they encounter warnings and bypass them.

Although MSFT etc. have started to remove a revoked certificate or a deprecated certificate authority, they cannot do so automatically for all of their products. For example Win XP and prior OS will require an update.

But of course users of archaic products are by definition reluctant to install updates. The revoked certificate serial numbers are published in a Certificate Revocation List (CRL), which can be manually imported and consumed on most platforms; on Windows via certmgr.msc, on OSX via KeyChain, or directly into some browsers, like Firefox.

Enabling certificate revocation checking in each browser has in the past been suggested to users to benefit from past and future revocation information. But, as installed by updates or received from the manufacturer, neither Internet Explorer 8 nor Firefox have certificate revocation options set to safe defaults. Internet Explorer 8 has server certificate revocation checking off by default and Firefox only has Online Certificate Status Protocol (OCSP) revocation enabled. Microsoft has changed the default in Internet Explorer 9 to have server certificate revocation checking enabled by default. This leaves many systems vulnerable,

What is needed is a better, easier, and more proactive system and apparatus which can protect our clients from uncontrolled trusted certificates and to more quickly respond to hacks on certificate authorities than conventional best practices.

### BRIEF DESCRIPTION OF THE DRAWINGS

The appended claims set forth the features of the invention with particularity. The invention, together with its advantages, may be best understood from the following detailed description taken in conjunction with the accompanying drawings of which:

FIG. 1 shows a block diagram of typical network architectures;

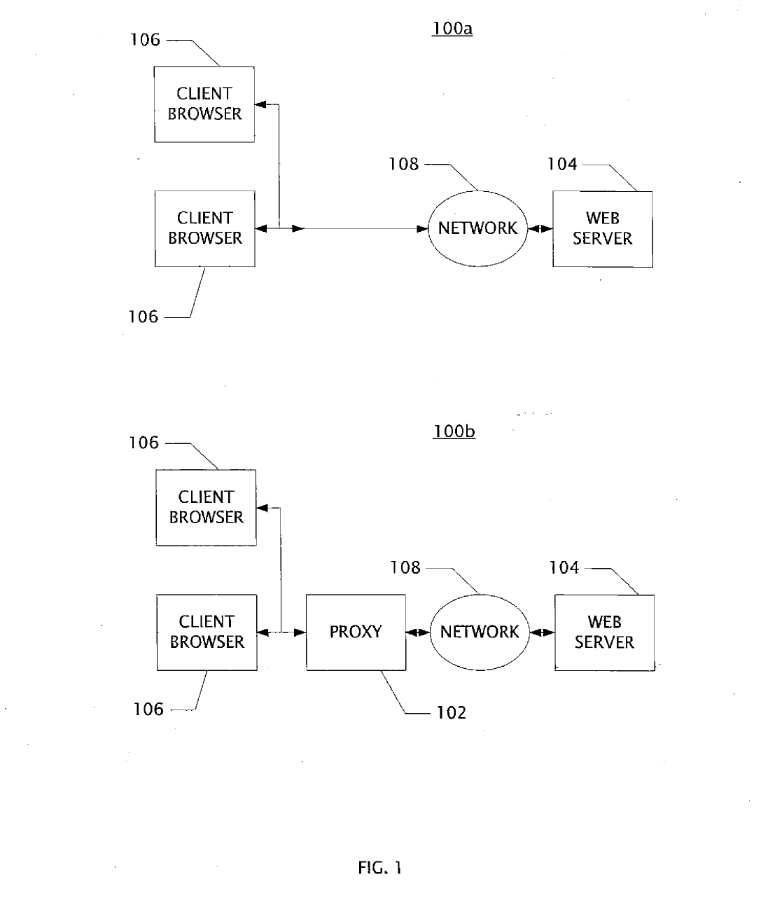

FIG. 2 is a block diagram of a hardware architecture providing structural elements;

FIG. 3 is a block diagram of interconnected circuits of an exemplary apparatus;

FIG. 4 is a block diagram of interconnected circuits of another embodiment of the apparatus; and

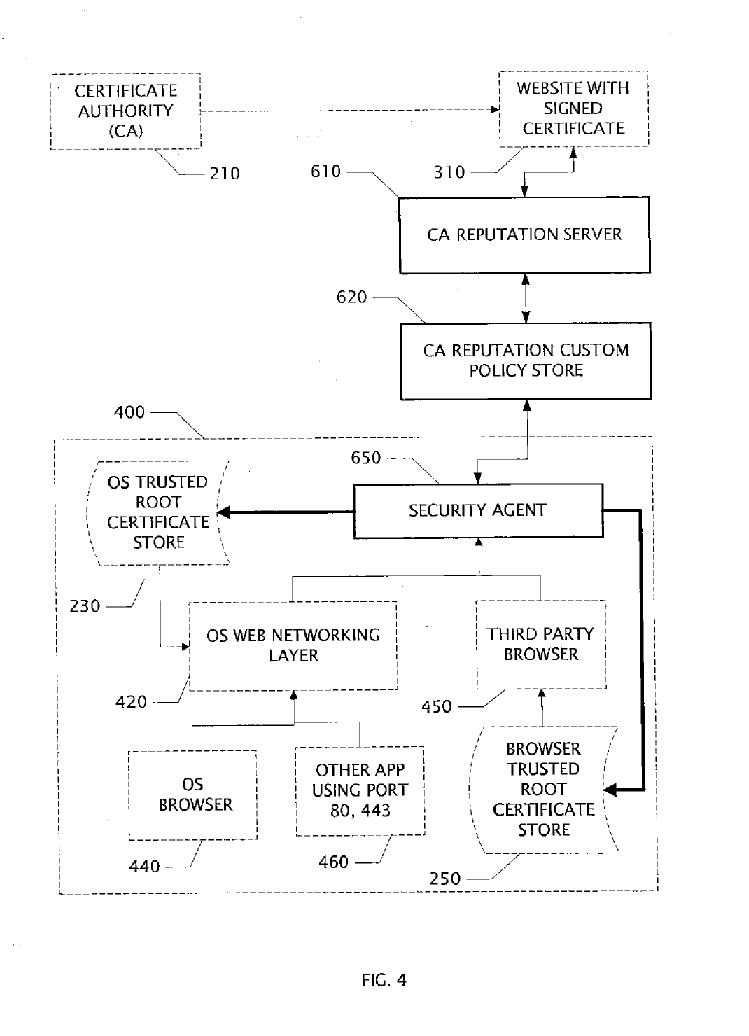

FIG. 5 is a flow diagram of a method.

### SUMMARY OF THE INVENTION

The inventors have devised a system, apparatus, and method to respond quickly to hacks on certificate authorities in order to protect a plurality of service clients.

The concept is that we, at Barracuda Central, will maintain our own reputation databases on public Certificate Authorities. We will also expose to customers to specify custom policy based on their own trust of public Certificate Authorities and even their own private certificate servers, such as their Microsoft Certificate Servers or other third party products. The resulting policy stores are accessible to a proxy installed between the endpoints and a website presenting a certificate or a man-in-the-middle attacker spoofing the website.

### DISCLOSURE OF EMBODIMENTS OF THE INVENTION

An aspect of the invention is an apparatus disposed between a website having a certificate signed by a certificate authority and an endpoint which requests a TLS connection to the website. The apparatus is comprised of circuits which may be embodied as one or more processors configured by software program products encoded in a non-transitory computer readable medium. An aspect of the invention is the computer executed method steps for receiving, transforming, and transmitting electronic signals in a network attached apparatus.

One aspect of this invention is an apparatus to enforce trust policy for certificate authorities comprising:
a (Barracuda) certificate authority reputation server;
a certificate authority reputation custom policy store coupled to the CA reputation server, and a proxy;
the proxy coupled to the custom policy store and further coupled to an operating system web networking layer circuit within an endpoint; wherein the apparatus is communicatively disposed between the endpoint and a website which presents a certificate signed by a certificate authority in response to a request from the endpoint.

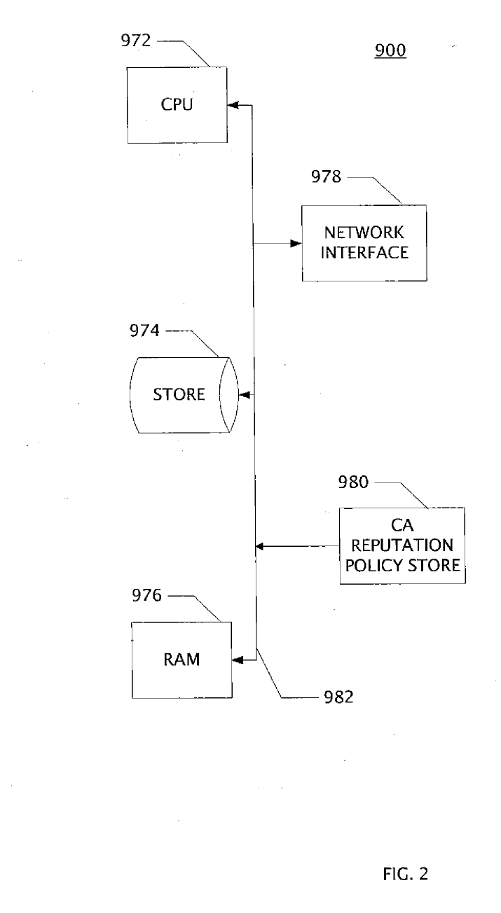

FIG. 2 is a block diagram of a suitable hardware architecture for supporting a proxy, in accordance with one aspect of the present invention. The hardware architecture 900 includes a central processing unit (CPU) 972, a persistent storage device 974 such as a hard disk, a transient storage device 976 such as random access memory (RAM), a network I/O device 978, and a certificate authority reputation policy store 980 all bi-directionally coupled via a databus 982.

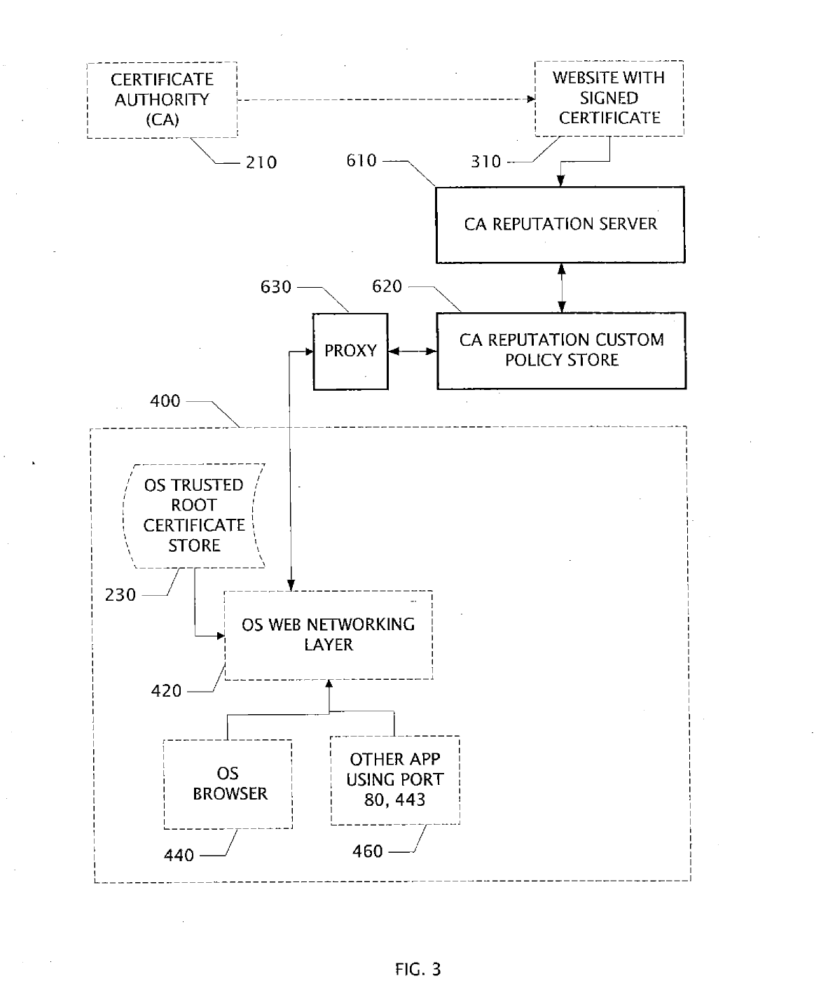

FIG. 3 illustrates one exemplary network environment within which the claimed apparatus operates. Included are the things that are “hackable.” These include the CA 210, the OS trusted root certificate store 230 and the browser trusted root certificate store 250. Also suggested at the top is an exemplary destination website 310 which presents a certificate signed by the CA 210.

What we are putting between the destination website 310 and the OS Web networking layer 420 is a multi-tiered security system 600, including a proxy 630, a mechanism for customers to set their own custom policy for certificate authorities 620 and a Barracuda CA reputation server 610. The operating system web networking layer circuit 420 of an endpoint 400 is further coupled to an operating system root certificate store 230, and at least one of an operating system browser 440 and another application 460 using port 80, 443. The proxy protects the endpoint from a fraudulent certificate presented by a website 310 even when no certificate revocation list has been received and before any trusted root certificate store has been amended with an operating system or browser update. A certificate authority reputation server 610 receives a notification of certificate revocation or loss of confidence in a specified certificate authority. The server amends a certificate authority reputation custom policy store 620 with this notification which is immediately available to the proxy 630. When the proxy determines that a connection is being made with a website whose certificate or certificate authority has a reputation issue it can take one or more of the following proactive actions.

In an embodiment the proxy is coupled to an operating system web networking layer circuit 420 of an endpoint 400 wherein the operating system web networking layer circuit may be further coupled to an operating system root certificate store 230, and at least one of an operating system browser 440 and another application 460 using port 80, 443.

In an embodiment the proxy is further coupled to a third party browser circuit 450 of an endpoint wherein the third party browser circuit is further coupled to browser trusted root certificate store 250.

In an embodiment, the proxy is a processor configured to read a trusted root certificate store, read a certificate authority reputation custom policy store, and determine that certificate may not be acceptable. The proxy is logically within a secure zone with the certificate authority reputation server and the certificate authority reputation custom policy store.

Another aspect of the invention is a method for operating a proxy coupled to an endpoint comprising:
receiving certificate authority signed certificate presented by a website,
reading a certificate authority reputation custom policy store and providing a message to an endpoint without completing the connection to the website. In an embodiment, the method is redirecting the browser to a webpage that states a policy or provides an explanation for the redirection away from the desired website.

In an embodiment, the message is a block message and further requests to or responses from the website are blocked.

In an embodiment, the message is a warning message and further requests to or responses from the website are enabled after affirmative override. In an embodiment, the webpages are rewritten before they are delivered to the browser. This may include adding a background layer with additional warning. This may include disabling form fields that relate to a phishing attack. This may include displaying the content within a window accompanied by additional cautionary messages. Content may be permitted in only one direction from or to a website presenting a questionable certificate. Binary files and scripts may be rewritten to not be executable within the endpoint. The TLS connection may be replaced with a man-in-the-middle tandem connection which allows filtering and rewriting of content uploaded to or downloaded from a website with a certificate reputation issue. The invention thus protects a user from a man-in-the-middle attack even when the user's trusted root certificate store has been compromised.

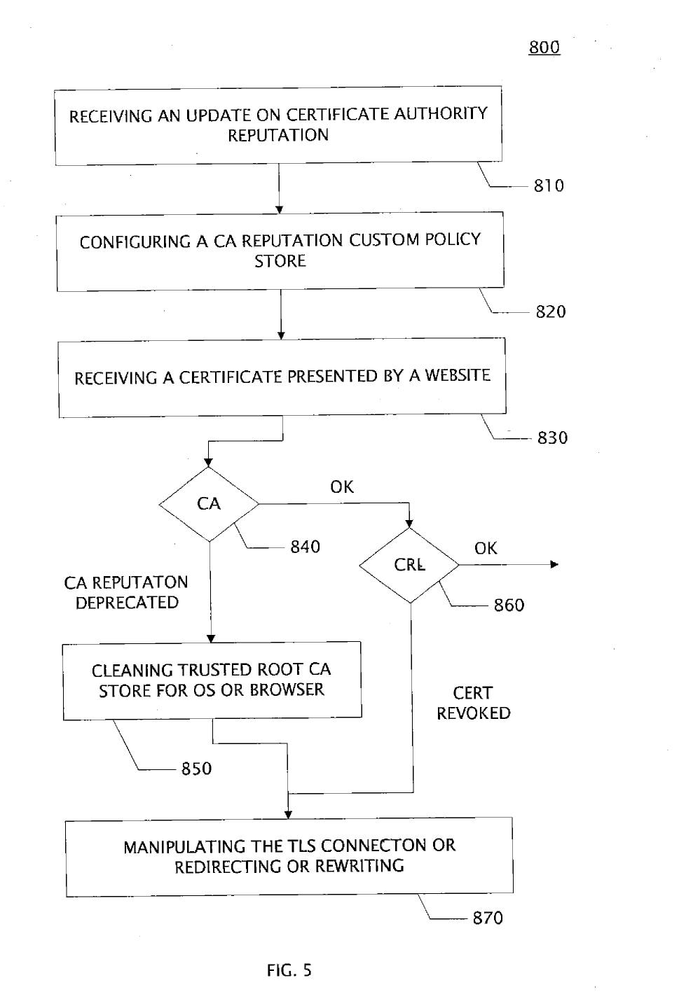

Another aspect of the invention is a method 800 in FIG. 5 for operating a Certificate Authority Reputation Enforcement Hyper Agent in the apparatus comprising:
receiving an update to a barracuda certificate authority reputation server of fraudulent certificate generation at a certificate authority 810;
configuring a certificate authority reputation custom policy store with revised policies 820;
receiving a certificate presented by the website 830;
determining 860 that the certificate presented by the website has been revoked or that the certificate authority has been deprecated 840 in the custom policy store; and
manipulating a TLS connection to the website 870. Manipulating may mean simply blocking the connection, decrypting and reencrypting after processing the content, redirecting to a different uri, removing or inserting additional content, scrambling user information that may subject to a phishing attack, or slowing the connection.

Through our own suite of products, we can enforce an even more restrictive set of reputation as is natively supported by their own endpoints (e.g., Windows operating system and Internet Explorer, Mac OS X and Safari, Mozilla Firefox, Google Chrome, etc.), as well as any applications or application frameworks (such as Java, PHP or any other framework that utilizes its own SSL handling) that rely on the operating system's network services layers.

We can do this at multiple levels, including through.
CA Reputation Server 610,
CA Reputation Custom Policy Store 620,
Proxy 630. (Barracuda Web Filter, Barracuda Web Security Flex). In the proxy, we can also enforce policy by blocking, logging, redirecting or rewriting traffic.

The present invention protects any client of TLS certificates whether they are enrolled or not if they are downstream of the proxy. It is particularly effective against phishing and man-in-the-middle attacks and requires no privileges at all within the endpoint.

Of course, this technology not only protects against hacks on certificate authorities. It can also protect against hacks on the endpoints that corrupt the trusted root certificate store, such as malware that might add entries to the trusted root certificates list, to facilitate trust relationships with invalid stores.

### MEANS, EMBODIMENTS, AND STRUCTURES

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated.

Any of the operations described herein that form part of the invention are useful machine operations. The invention also related to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a non-transitory computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network-coupled computer system so that the computer readable code is stored and executed in a distributed fashion. Within this application, references to a computer readable medium mean any of well-known non-transitory tangible media.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

The invention is easily distinguished from conventional systems because of the following.

The proxy can enforce trust policy by rewriting, redirecting, blocking or logging traffic before it even hits the browser or OS Web networking layer.

Again, the advantage here is fast response times, independent of the ability to launch certificate revocation lists or waiting for OS or browser updates. Policies can take effect immediately for all Web traffic on any platforms protected by the proxy. There are also a number of claims we can make for management, including the ability for organizations to set policy without rolling out their own certificate authorities, locked down desktops, etc.

What is claimed is:

1. A method for operation of a certificate authority reputation enforcement apparatus, the method comprising:
receiving an update to a certificate authority reputation server of a fraudulent certificate generation event at a certificate authority (CA);
reconfiguring a policy store of the certificate authority reputation server with at least one revised policy;
receiving a request to enable a transport layer security (TLS) connection to a website from an endpoint where in the endpoint is coupled to one of an operating system trusted root certificate store and a browser trusted root certificate store;
determining the condition that a certificate presented by the website has been revoked or that the CA of the certificate has been deprecated in the policy store of the certificate authority reputation server; and
blocking the request to enable TLS connection to the website which presented the certificate.
